(19) United States
(12) Patent Application Publication
(10) Pub. No.: US 2013/0305537 A1
(43) Pub. Date: Nov. 21, 2013

(54) Means and Method for Shaving

(71) Applicant: Pal (Paul) Svedman, Malmo (SE)

(72) Inventor: Pal (Paul) Svedman, Malmo (SE)

(21) Appl. No.: 13/475,959

(22) Filed: May 19, 2012

(51) Int. Cl. B26B 21/44; B67D 7/06

(52) U.S. Cl. 30/41; 222/1; 222/192

(57) ABSTRACT

An invention aimed at improving the quality of cartridge razor shaves is disclosed. Before shaving, a lubricant, for instance an oil, is delivered from a dispenser directly to blades, plate-limited spaces and skin relubrication chambers of razor cartridges according to the invention or state of the art cartridges. During the razor's strokes, the delivered dose—releasably retained inside the cartridge by surface tension and adhesion—lubricates 1) between blades and skin, 2) between the razor interior structures, 3) between hair stubs and skin flakes draining outwards, as well as 4) the skin in the razor's path. The skin is prepared with lubricant from the same dispenser, spread manually with soap and water and eventually supplemented with a small amount of other lubricant. Residual cartridge lubricant facilitates complete rinsing and protects the blades from corrosion.

### FIELD OF THE INVENTION

The instant invention concerns shaving in general, and more particularly, but not by way of limitation, to shaving means and methods which result in closer shaves, improvement of razor cartridge glide, efficient draining of cut material, relubrication of skin after the razor's passage, increased cartridge functional life and enhanced shaving ecofriendliness.

### BACKGROUND

A prerequisite for an acceptable shave is that the skin is preliminarily prepared with lubricant to facilitate blade glide and a close cut. Pre-shave use of soap and brush has become variably substituted by lubricating oils, foams, creams, hydrogels and emulsions. These means are contained in reservoirs or tubes from which an amount of lubricant is pressed out either by manual compression or gas pressure, and spread over the area to be shaved with or without use of a brush. None of these auxiliary means result in a clear advantage beyond oils when comparing shaving quality and number of daily optimal shaves with the same razor cartridge.

Pluri-blade cartridge razors fitted with 2 to 6 blades in parallel are presently in use. During each stroke, the skin underlying the blades of such razors becomes stretched by pressure and pull exerted both through the anterior skin friction-providing long cartridge bar and the compressing sliding sidebars as the razor is moved forward. The said lubricant disadvantageously becomes partly wiped away, first by the anterior friction bar, then by each passing blade, and finally by a sliding posterior bar with or without a lubricating strip. This stepwisely reduces the amount of originally applied lubricant present inside the moving cartridge, and successively increases the blades friction with skin—most markedly at the most posterior blade. Without renewed skin lubrication further razor strokes on the same skin will lead to more lubricant depletion. Thus, none of the technologies according to the state of the art allow lubrication within the cartridge frame beyond a degree of relative deficiency, increasing with the interior area, the number of blades in the cartridge, and the number of razor strokes. A state of the art lubricating strip fixed to the posterior transverse bar may transiently lubricate the skin posterior to the cartridge, but such an eventual effect has not been reliably demonstrated and will within a few days wear off with frictional disintegration of the strip.

A key function of state of the art cartridges is the efficacy of drainage of cut skin material as the razor is being moved forward. In vital microscopy of pre-shave skin, the skin surface keratin layer is irregular and cobblestone-like under magnification, with protrusions around protruding hair stubs.

Also, superficial skin may be lax, with wrinkle formation, and below, fibrosis—changes increasing with degree of sun exposure and age. During passage of the razor, these irregularities become frictionally compressed and scraped by the blades, while protruding hair stubs become cut. Keratin disengages spotwise as flakes mixed with said stubs, causing plug formation below and between the blades and associated bars, which cause widening of blade-skin distances. Residual frictional contact between skin keratin layers and blades leads antegrade to skin compressional wrinkling. Both said widening of skin-blade distances and residual friction facilitate razor burns or bleeding points and are important in preventing completely close shaves.

Additionally, used, rinsed cartridges become increasingly exposed to oxidation from the air. This dulls the blades, enhances friction and increases the number of cuts. To counteract such wear, cartridge razor blades may be exposed to cryogenic edge-preserving manufacturing measures which can double cartridge life.

External devices for adding lubrication to razor cartridges, not specifically directed at cartridge blades and adjacent spaces, have been described, as have razors containing a built-in pump-driven refillable lubrication chamber in the handle, with channels to apertures behind the blades. Disadvantageously, cartridges and blades in these razors cannot be directly, completely and continuously be lubricated on all frictional surfaces in connection with the shave, and poor access for cleansing the chamber and tube supply units may create hygienic problems.

From an ecological perspective, the total volume of used cartridges and lubricant containers or tubes, frequently with ecologically doubtful content, become variably disposed of as required. Their volume and content should thus be reduced as much as possible. Disadvantageously, present-day multi-blade razors require quite frequent cartridge replacement to sustain optimal shaving quality. This implies excessive accumulated costs which may prevent more general use of an otherwise practical technology in many parts of the world.

In summary, methods and devices allowing controlled pre-shave application of lubricant directly to blades and associated surfaces and spaces inside the cartridge, whereby such applied lubricant becomes retained in a thin layer also after the shave in order to 1) improve local lubrication of the skin beneath and behind the cartridge with each stroke of the razor, 2) facilitate the closest possible shave, 3) facilitate outwards drainage of stubs and keratin between blades and adjacent structures, 4) preserve blade quality through post-shave retention of lubricant on blades, 5) extend blade life, and 6) reduce the burden on the environment caused by the present-day large volumes both of razor cartridges and preshave lubrication means—are lacking.

### SUMMARY OF THE INVENTION

It is a general objective to improve shaving.

It is a further objective to provide devices and methods which improve and facilitate the shaving process.

It is a further objective to provide a lubricant dispenser which allows reproducible lubrication of razor cartridges interiors.

It is a further objective to provide a lubricant dispenser which also allows pre-shave lubrication of the skin area to be shaved.

It is a further objective to provide razor cartridges which are especially adapted to optimize such delivered topical lubrication according to the above.

It is a further objective to improve the eco-friendliness of the shaving procedure.

The invention consists of two shaving devices which, functionally connected by the user, improve razor cartridge lubrication and within cartridge performance (i.e. closeness of shave and lack of lesions per shave, and over time). The first of these devices is a dispenser used for delivering pre-shave lubrication—preferably but not necessarily and oil—to razor cartridges as well as to skin requiring shaving, all according to the invention. The dispenser comprises a reservoir from which dosing is accomplished either by manual compression or by spray including gas pressure activation in which the reservoir content is set under pressure according to the state of the art.

A neck of the device is of sufficient length to allow visual control of the delivery, and ends in a preferably narrow nozzle which may or may not fit the width of a razor cartridge. The nozzle typically has a material yield which prevents razor blade damage when in moving contact during razor cartridge lubrication. The nozzle may be supported by dosing stabilization means, either single- or bi-directionally, and with these said means fixed to the dispenser reservoir or neck. The dispenser aperture may be closed compressively and reversibly by an elastic plug once an overlying lid is screwed in place over the reservoir. The dispenser is either used in combination with razor cartridges according to the invention, or with cartridges according to the state of the art. The lubricant is preferably delivered to the blades and interior cartridge under vision with the dispenser aperture in moving contact with upwards exposed blades and adjacent spaces, see below. Lubricant may also be delivered from the dorsal side of the cartridge.

Pre-shave skin lubrication may combine drops of oil spread with soap and water with a small volume of another state of the art lubricant—for instance a foam or cream—see below.

During each razor stroke, the delivered lubricant, adhesively and reversibly connected with the cartridge interior structures including interior chambers, becomes successively released by adhesional and surface tensional contact with the underlying moving skin and with hair stubs protruding between the blades. This facilitates both atraumatic close cutting of stubs as well as efficient drainage to the exterior between the blades of said stubs and associated keratinous skin flake material. The applied lubricant prevents clogging of the cartridge for the duration of the shave, and advantageously resides in place albeit in lesser dose also after rinsing, see below.

Complementary devices according to the invention are pluri-blade cartridges with 3 to 6 blades with posteriorly located cartridge skin relubrication chambers or chamber, from which the skin posterior to the cartridge becomes continuously lubricated during each razor stroke—allowing the following strokes to be made on skin previously lubricated from the said chamber or chambers.

When using the said dosing device in combination with state of the art razor cartridges, lubricant is likewise delivered adhesionally to the interior cartridge including exposed blades and spaces. In this application, the open space between the most distal blade and the interior side of the posterior frame functions as a skin relubrication chamber, albeit less voluminous than the double chambers described above.

Lubricants applicable with the invention, i.e. for cartridge as well as primary skin lubrication, comprise natural or mineral oils, eventually with silicone in trace amounts for the cartridge, and, in order to decrease the environmental load while giving in to well-being, but small amounts of secondary products like foams, emulsions, creams or hydrogels. The lubricants may or may not contain emollient, fragrants, healing or antiseptic substances. Aloe vera, vitamin E, menthol, skin protectants or antiseptics may be included in the preparation. Inclusion of a natural green color may indicate the eco-friendly properties of the invention. One such example is the nontoxic green dye from Chlorella algae.

To sum up, razor cartridges—whether according to the invention or state of the art, are thus suitably lubricated pre-shave with oil—eventually with a trace of silicone—applied to the surfaces and spaces inside the cartridge frame. Skin lubrication is advantageously accomplished with the same lubricant(s), spread with hot water and some soap, eventually combined with foam, emulsion, cream or hydrogel. Assessment of cartridge residual lubricant: (1) A thin 5 blade cartridge was used according to the invention, and rinsed post shaving with hot water. Its metal structures were found to adhere a residue of 0.1 mg of oil, corresponding to a lubricated surface of 1.25 cm². (assessed with said volume placed between glass plates under compression). This cartridge-retained lubricant allows the blades to be readily rinsed, facilitates quick, direct and full washing of the cartridge, counteracts blade oxidation and corrosion and contributes to markedly prolonging cartridge life (see below). (2) Three cartridges with 2, 3 and 5 blades, used for face and neck shaves, were lubricated by sliding the nozzle aperture longitudinally along the full width and length of the external side of the blades and adjacent spaces in one stroke, compressing the reservoir lightly in the process. The delivered lubricant dose was found to be 0.1 mL in a 2 blade cartridge and 0.4 mL both in the 3 and a 5 blade cartridges (the latter thinner cartridge approximately equal in volume to the three-blade device).

Effects of Facial Shave Lubrication.

1. Between-day skin bleeding comparison: A volunteer requiring face and anterior neck shaves once daily was tested. A 5 blade razor cartridge with vibration was used. Preshave skin face/neck oil lubrication without intra-cartridge lubrication resulted in 7 bleeding points on day 1; on day 2 with cartridge lubrication 1 minor bleeding point observed on uneven skin; on day 3 without cartridge lubrication 7 bleeding points; and on day 4 with cartridge lubrication zero bleeding points. In the cartridge lubricated shaves, the skin felt completely smooth to fingertip glide.

Conclusion: Superior atraumatic glide was evident after shaves with cartridge lubrication.

2. Sequential skin shaving quality comparison: A volunteer requiring face and anterior neck shaves once daily was tested during 3 years with regard to shaving quality using three-blade razor cartridges without (year 1) or with (years 2 and 3) cartridge lubrication according to the invention. Skin preparation consisted throughout of hot water and touch of soap with 6 drops of oil spread by hand. (1) Control testing year 1, successive daily shaves. Minor bleeders (2-6) were observed on days 1-5, and again, increasingly from day 26-30, then combined with more residual hair stubs, resulting in switch to a new cartridge. (2) Active testing (year 2 and 3, successive daily shaves). Skin and cartridge oil lubrication according to the invention (same lubrication as in control test above). Closer shaves than in controls were noted protractedly. Only solitary and infrequent bleeding points were observed initially with a fresh cartridge. Bleeders and/or unacceptable residual stubs were first observed on day 120, 120, 125, 130, 113, 90, 125 and 120—corresponding approximately to a fourfold increase in cartridge life.
3. Skin lubrication. Such lubrication based on oils on one side and small volumes of foam, emulsion, cream or hydrogel was found feasible in practical tests. Neither blade damage to skin of any importance, nor infection, were observed.

Provided in one embodiment is a method for delivering lubricant to a razor cartridge, comprising:

(a) employing a dispenser having lubricant therein and from which said lubricant is delivered through application of force;
(b) positioning said dispenser adjacent a razor cartridge frame having blades with an interior region therebetween; and
(c) applying force to said dispenser to cause said lubricant to be dispensed to interior region of said razor cartridge frame and adhere to external and internal surfaces of said blades.

Another embodiment includes a razor lubricant dispenser for a razor cartridge frame, which includes:

a housing and a nozzle connected thereto, wherein said housing has a lubricant therein and from which said lubricant is delivered through application of force, and wherein said nozzle has a nozzle opening which is configured to deliver lubricant substantially into and not outside of a predetermined area of the razor cartridge frame.

In conclusion, by virtue of the instant invention, local lubrication of blades and interior parts of razor cartridges 1) effectively reduces friction as shown by reduction or absence of bleeding points and closer shaved skin—improving the shaves and prolonging cartridge functional life, 2) contributes to an ecologically sound environment by minimizing the volume of razor cartridges to be recycled, as well as by eliminating the need for voluminous and environmentally undesirable preparatory lubricant preparations, and 3) may be combined with pre-shave skin lubrication of small doses of state of the art skin shave lubricants.

### BRIEF DESCRIPTION OF THE DRAWINGS

Embodiments of the present invention will now be described by way of example only, and with reference to the accompanying drawings of which:

FIG. 1A shows a cross-sectional view of a dispenser for manually delivering lubricant to a razor cartridge according to one embodiment of the invention with partial reveal.

FIG. 1B shows a cross-sectional view of a dispenser for manually delivering lubricant to a razor cartridge according to one embodiment of the invention with partial reveal.

FIG. 1C shows a cross-sectional view of a dispenser for manually delivering lubricant to a razor cartridge according to one embodiment of the invention with partial reveal.

FIG. 1D shows a cross-sectional view of a dispenser for manually delivering lubricant to a razor cartridge according to one embodiment of the invention with partial reveal.

FIG. 2A exemplifies a nozzle for spreading lubricant inside razor cartridge frames.

FIG. 2B exemplifies a nozzle for spreading lubricant inside razor cartridge frames.

FIG. 3A shows a schematic frontal view of a lubricant dispenser fitted with a uni-directional nozzle-guiding member.

FIG. 3B shows a schematic side view of a lubricant dispenser fitted with a uni-directional nozzle-guiding member, and

FIG. 3C shows a schematic functional frontal view of a dispenser fitted with a bi-directional nozzle-guiding member.

FIG. 3D shows a schematic functional side view of a dispenser fitted with a bi-directional nozzle-guiding member.

FIG. 4A shows a functional methodological view of razor cartridge being loaded with lubricant longitudinally from a schematic dispenser according to the invention.

FIG. 4B shows a razor cartridge according to the state of the art being loaded with lubricant from dispensers according to the invention.

FIG. 4C shows a razor cartridge according to the state of the art being loaded with lubricant from dispensers according to the invention.

FIG. 4D shows a razor cartridge according to the state of the art being loaded with lubricant from dispensers according to the invention.

FIG. 4E shows a first step of two-step transverse loading.

FIG. 4F shows a first step of two-step transverse loading.

FIG. 5A shows a schematic, functional cross-sectional view of a single-dose delivery device for cartridge lubrication according to the invention.

FIG. 5B shows a spray dispenser example with narrow nozzle for lubricating razor cartridges according to the invention.

FIG. 6A shows a razor cartridge according to the invention fitted with double posterior skin relubrication chambers from below.

FIG. 6B shows a cross-sectional view.

FIG. 6C illustrates chambers of the cartridge are higher.

FIG. 6D includes a widened anterior relubrication chamber.

FIG. 7A shows a schematic cross-sectional relating to FIG. (6A).

FIG. 7B shows a schematic sectional relating to a razor cartridge.

FIG. 7C shows a schematic sectional relating to a razor cartridge.

FIG. 8A shows a schematic cross-sectional view of a razor cartridge according to FIG. 7A.

FIG. 8B shows a schematic sectional view of a razor cartridge according to FIG. 7B.

FIG. 8C shows a schematic sectional view of a razor cartridge according to FIG. 7C.

FIG. 9A shows schematic cross-sectional functional view of a cartridge according to the invention about to be loaded with lubricant.

FIG. 9B shows schematic cross-sectional functional view of the cartridge is turned around, the lubricant retained releasably by adhesion.

FIG. 9C shows schematic cross-sectional functional view of the cartridge used for shaving.

FIG. 10A shows schematic cross-sectional functional view of a cartridge according to the state of the art being loaded with lubricant.

FIG. 10B shows schematic cross-sectional functional view of the cartridge used for shaving.

FIG. 11A shows a razor cartridge according to the invention with widened relubrication chamber and posterior non-degenerating reloadable lubricant distributioning strip according to the invention.

FIG. 11B shows a cross section of razor cartridge according to the invention with widened relubrication chamber and posterior non-degenerating reloadable lubricant distributioning strip according to the invention.

FIG. 11C shows the cartridge loaded, turned around and used for shaving.

### DETAILED DESCRIPTION

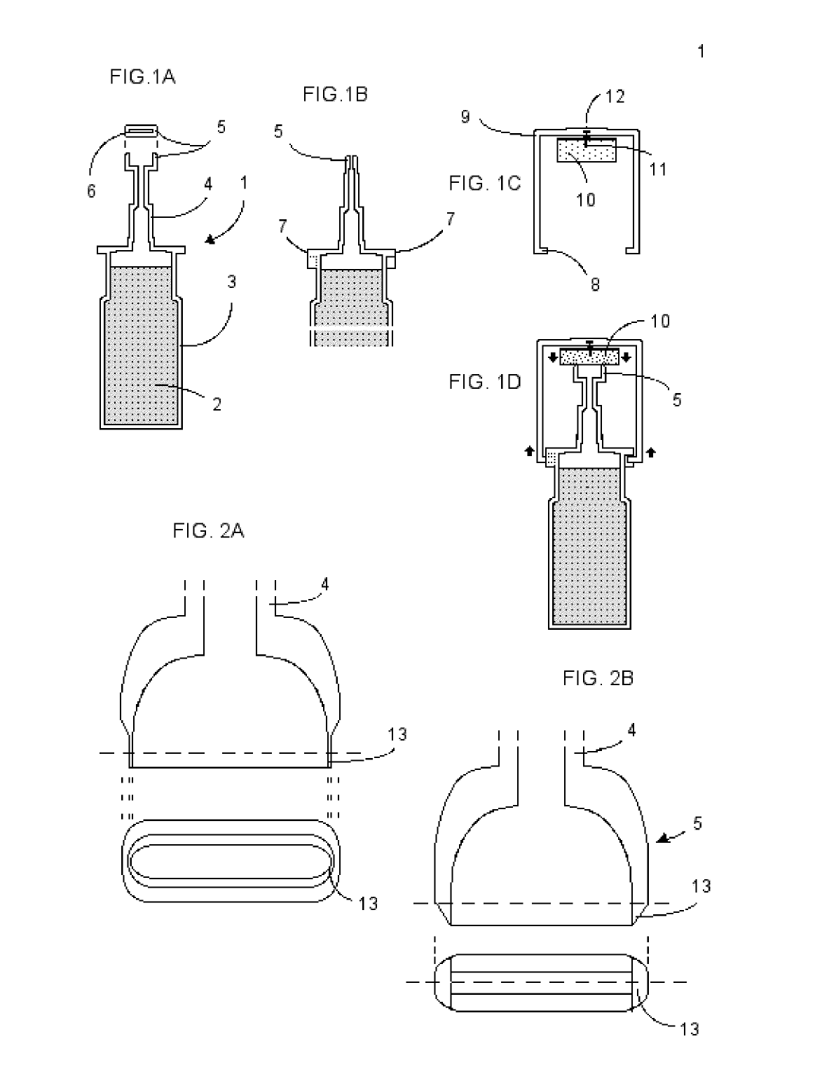

Referring now to the drawings, FIGS. 1A-D shows a lubricant dispenser 1 according to the invention, in FIGS. 1A-B a frontal and side view of an example of dispenser 1 according to the invention pre-filled with lubricant 2, for instance an oil, in frontal and side view. Dispenser reservoir 3, containing lubricant 2 preferably consists of elastic polymer or rubber readily compressible between thumb and forefinger. Its less elastic or rigid polymer neck 4 is fitted with wide flat nozzle 5 with aperture 6. FIG. 1B shows the dispenser in a partial side view. Nozzle 5 is typically elastic with material yield which prevents razor blade damage when in moving contact with the blades during lubrication. The protruding ridges 7 fitted superiorly on the external wall of reservoir 3 comprising dependent block on either side constitute the receiving end for matching dependent ridges 8 inside lid 9 in FIG. 1C—and locks by rotation. FIG. 1C shows lid 9 interiorly fitted with compressible cylindrical plug 10 made for instance of polymer with or without cells, the plug 10 suited for maintaining compressional nozzle occlusion. Plug 10 is either mounted rotatably over axis pin 11, in turn is fixed in roof 12, or it is stably fixed and rotatorily sufficiently adaptable to maintain occlusion in the event that the lid 9 is instead locked by a screw mechanism. FIG. 1D shows the device with lid closed, exhibiting occlusive compression between nozzle edges 5 and plug 10 (see arrows). Said dispenser may alternatively be rigid and fitted with a manually operable volume-reducing means according to the state of the art. FIGS. 2A-B shows the nozzle 5 in detail, with medialization of the lateral walls to allow better access and visual control of the dosing process. With distally reduced lateral width 13, the aperture of nozzle 5 matches the full inner transverse interior width of a razor cartridge according to the invention or partly or fully the said width of cartridges according to the state of the art which are to be loaded with lubricant. With regard to the latter, nozzle 5 preferably has an inner width corresponding to the breadth of at least 2 blades. The nozzle typically consists of elastic or rigid polymer, for instance polyester.

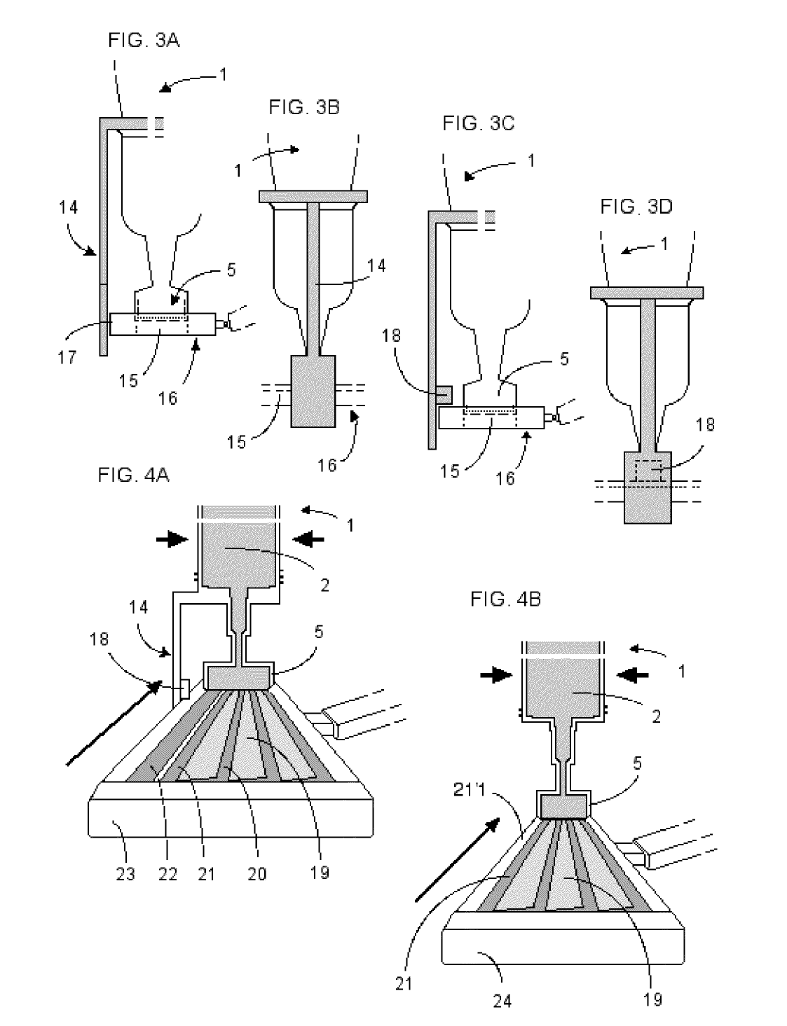

FIGS. 3A-3D show means for stabilizing the delivery of lubricant to the razor cartridge. In FIG. 3A-B lubricant dispenser 1 has been fitted with uni-directional nozzle guiding member 14, which stabilizes the delivery of lubricant through nozzle 5 to the interior 15 of cartridge 16 (frontal and side view respectively), said guiding member 14 in direct sliding contact with the vertical side of long bar 17 of cartridge 16. In FIG. 3C-D guiding member 14 has been complemented with horizontal member 18, the latter in sliding contact with the superior side of cartridge 16, stabilizing the delivery from above.

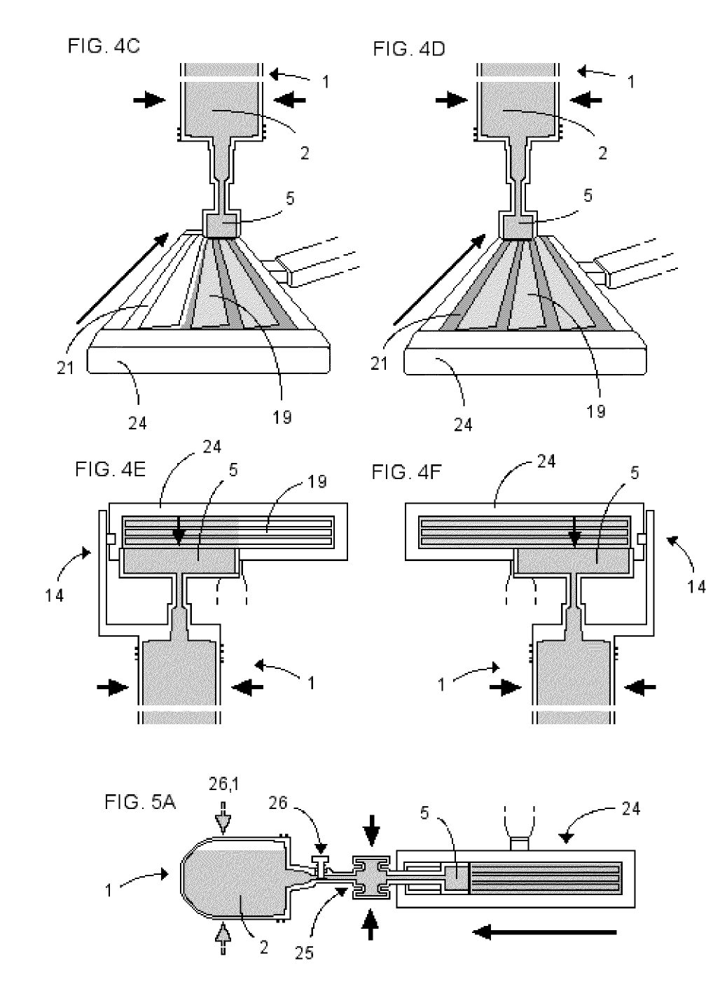

In FIGS. 4A lubricant 2 is being delivered from dispenser 1—the latter fitted with bilaterally directed nozzle guiding members 14 and 18—to blades 19, adjacent underlying spaces 20, skin relubrication chambers 21 (anterior) and 22 (posterior) of a 3 blade razor cartridge 23 according to the invention. Dispenser 1 is compressed (manually or mechanically) while in sliding motion to achieve loading. In FIG. 4B the lubricant dispenser 1, without nozzle guiding member(s) 14 and 18, is being used to deliver lubricant to a state of the art 3-blade state of the art razor cartridge 24 including its (acting) skin relubrication chamber 21 behind the blades, and lubrication strip 21′1. FIGS. 4C-D show a state of the art 3 blade razor cartridge 24 being loaded with lubricant in two parallel, adjacent strokes. Depending on the circumstances (duration of shave), one or two fully covering double strokes may be recommended, and will be readily adhered within the cartridge 24. FIGS. 4E-4F show dispenser 1 with wide nozzle 5, the latter half as long as the interior of cartridge 24, during loading of said cartridge 24 transversely in two adjacent steps, both while moving the nozzle over and away from the cutting edges of the blades 19. A single step transverse procedure with a twice as wide nozzle 5 is an alternative loading procedure.

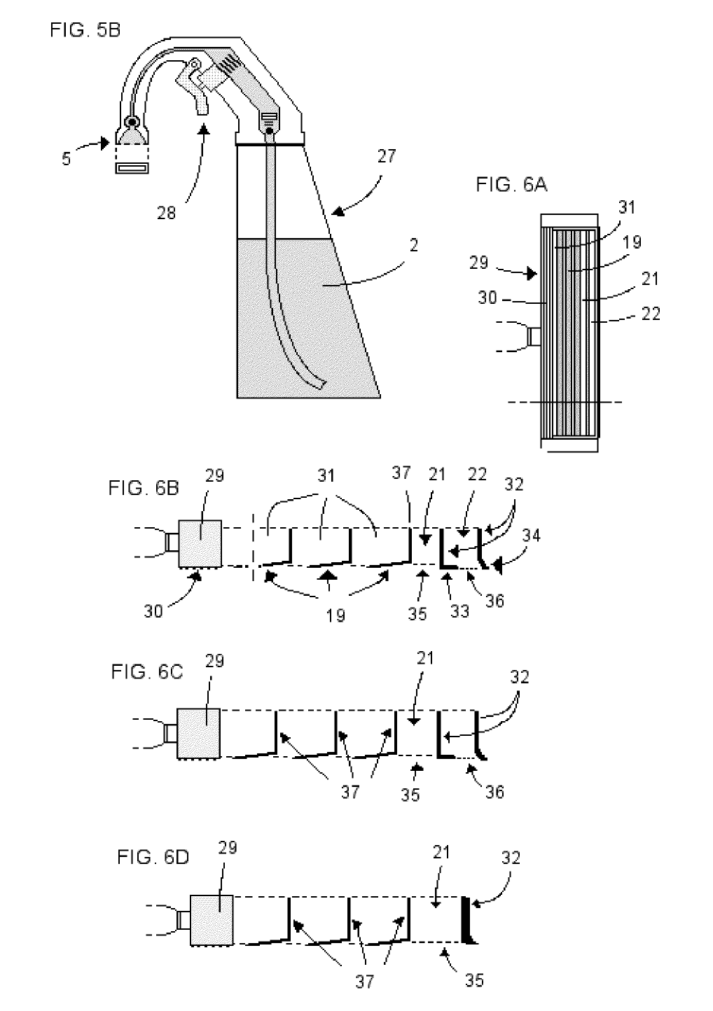

FIG. 5A shows a single-dose dispenser 1 fitted with transparent single dose chamber 25. Switch 26 has been activated occludingly after lubricant 2 has filled dispenser 1 including nozzle 5 compressingly (see arrows 26, 1). Single dose chamber 25 is being compressed manually (see black arrows) to apply this said dose to state of the art three-blade cartridge 24, and dosing is underway. FIG. 5B shows a positive pressure dependent manually operated spray bottle based dispenser 27, with lubricant 2, state of the art actuator 28, and flat nozzle 5, which during dosing is applied as previously disclosed.

FIG. 6A shows the underside of a 3-blade razor cartridge according to the invention fitted with anterior bar 29 with friction strip 30, blades 19, plate-limited spaces 31 followed by skin relubrication chambers 21 and 22. In cross-sectional view (FIG. 6B) the blades 19 are located dependently inside upwards and downwards open plate-limited spaces 31. Rigid vertical bars 32 limit said relubrication chambers posteriorly. During a shave, anterior and posterior rudders 33 and 34 direct successively released lubricant passage through dependent apertures 35 and 36 onto skin underneath and behind the cartridge, lubricating it efficiently for the next stroke. Each plate 37 connects with its blade 19 forming separate chambers. The vertical broken line anterior to blade 19 indicates that the cartridge may contain any number of blades compatible with a good or better shave. FIG. 6C shows a cartridge according to FIG. 6B except that plates 37 as well as the posterior bars 32 are higher, and anterior chamber 21 wider, creating space for larger lubricant volumes and allowing more extensive shaves without reloading. In FIG. 6D anterior relubrication chamber 21 is widened, and the posterior chamber eliminated in favor of solid posterior bar 32, making the cartridge less voluminous while maintaining a large chamber 21.

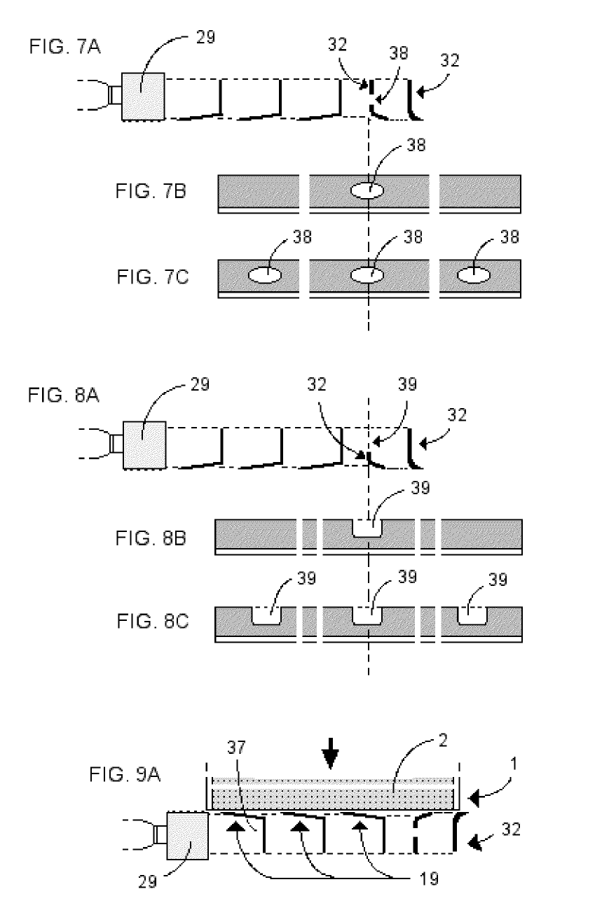

FIGS. 7A-C show a cartridge fitted with lubricant volume balancing means consisting of a single aperture 38 (FIGS. 7A, 7B) or multiple apertures 38 (FIG. 7C) in (anterior) plate 32 dividing the two posterior relubrication chambers.

FIG. 8A shows a cartridge fitted with between-space balancing of lubricant volume means comprising single (FIG. 8B) or multiple (FIG. 8C) upwards open apertures 39 in plate 32 dividing the two posterior relubrication chambers.

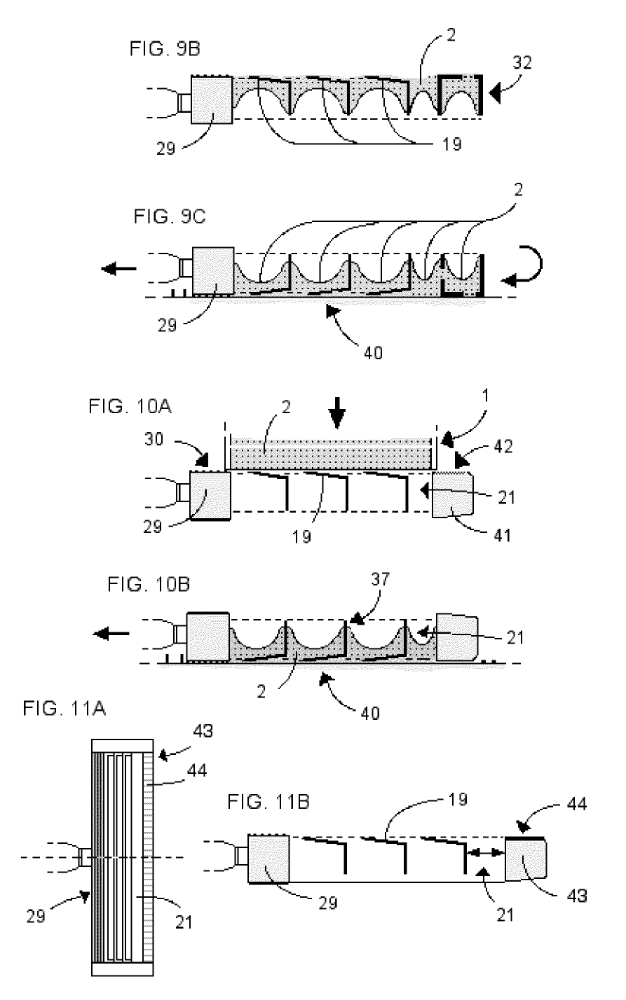

FIGS. 9A-B show in schematic operational sequence a razor cartridge according to the invention about to be loaded with lubricant 2 from dispenser 1 according to the invention. Once the dispenser 1 becomes compressed (see arrow) releasable lubricational contact is established first with blades 19 and subsequently plate-limited spaces to the sides and below (FIG. 9B). The adhered lubricant dose is kept in place by adhesion and surface tension. In FIG. 9C the cartridge has been turned around, and is used for shaving. Lubricant 2 is then in adhesional contact with the cartridge interior drainage spaces, the blades' surfaces and skin 40. Thus, keratin (skin surface layer) cut in thin flakes, and hair stubs, becomes readily drained into and through the said spaces above and eventually beyond.

FIG. 10A shows a three-blade razor cartridge according to the state of the art with anterior friction bar 29, (functional) lubrication chamber 21 and posterior bar 41 with lubricant strip 42 being loaded according to the invention with lubricant from fitting dispenser 1. FIG. 10B shows lubricant 2 kept in place by adhesional contact bilaterally to the blades, interior plates 37 and (functional) relubrication chamber 21 when the cartridge is turned around and used for shaving.

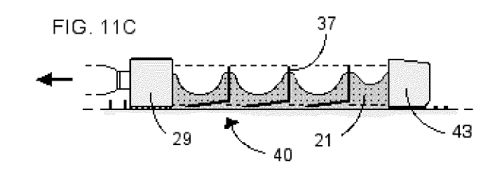

FIG. 11A shows a functional view of another cartridge according to the invention, in which anterior relubrication chamber 21 has been volumetrically increased compared with present state of the art (FIGS. 10A and 10B) in order to increase lubricant volume and improve skin lubrication. Posterior bar 43 is fitted with lubricant distributional grid 44. FIG. 11C shows such a cartridge, lubricant-loaded according to the invention in a (razor) stroke on skin 40.

It will be seen from the objects and method above and those apparent from the description, that modifications, derivations and improvements can be made without departing from the invention and it is intended that all matter contained in the above description and shown in the accompanying drawings shall be interpreted as illustrative and not in a limiting sense with respect to the claims appended hereto.

1. A method for delivering lubricant to a razor cartridge, comprising:
(a) employing a dispenser having lubricant therein and from which said lubricant is delivered through application of force;
(b) positioning said dispenser adjacent a razor cartridge frame having blades with an interior region therebetween; and
(c) applying force to said dispenser to cause said lubricant to be dispensed to interior region of said razor cartridge frame and adhere to external and internal surfaces of said blades.

2. The method of claim 1, wherein step (b) is performed by one of manual compression and gas pressure.

3. The method of claim 1, wherein said razor cartridge frame includes interior plates connecting and forming part of each said blade.

4. The method of claim 1, wherein said razor cartridge frame includes at least one posterior skin relubrication chamber.

5. The method of claim 1, wherein said dispenser nozzle opening is complementary to an interior area of said razor cartridge frame such that the dispensed lubricant becomes adhered to the external surfaces of said blades.

6. The method of claim 3, wherein said dispenser nozzle has an opening complementary to an interior area of said razor cartridge frame such that the dispensed lubricant becomes adhered to the external surfaces of said blades and said interior plates and at least partially filling plate-limited internal spaces.

7. The method of claim 4, wherein said dispenser nozzle opening is complementary to an interior area of said razor cartridge frame such that the dispensed lubricant becomes adhered to the external surfaces of said blades and said posterior skin relubrication chamber.

8. A razor lubricant dispenser for a razor cartridge frame, which includes:
a housing and a nozzle connected thereto, wherein said housing has a lubricant therein and from which said lubricant is delivered through application of force, and wherein said nozzle has a nozzle opening which is configured to deliver lubricant substantially into and not outside of a predetermined area of the razor cartridge frame.

9. The razor lubricant dispenser of claim 8, wherein said dispenser is configured to supply a predetermined dose of lubricant to said predetermined area.

10. The razor lubricant dispenser of claim 9, which includes a manually compressible single dose volume chamber.

11. The razor lubricant dispenser of claim 10, which includes an actuator fitted proximally to said chamber to enable delivery of said lubricant.

12. A spray or pump-driven dispenser for delivering lubricant to a razor cartridge, operated manually by means of an actuator, said dispenser fitted with a narrow nozzle which fits within the interior of a razor cartridge frame.

13. The dispenser according to claim 12, which includes at least one guiding member support allowing stabilization of said nozzle in position against a part of said razor cartridge frame during lubricant delivery.

14. The razor lubricant dispenser according claim 8, which includes at least one guiding member support allowing stabilization of said nozzle in position against a part of said razor cartridge frame during lubricant delivery.

15. The razor lubricant dispenser according claim 8, wherein said nozzle is made of translucent polymer not traumatizing to moving contact with a razor blade.

16. The dispenser according claim 12, wherein said nozzle is made of translucent polymer not traumatizing to moving contact with a razor blade.

17. A razor cartridge, which includes:
a plurality of blades, each having a plate portion forming a cutting portion and another interior plate portion forming a divider, an open blade-associated plate chamber between each said adjacent blades and at least one posteriorly open vertical plate-limited skin relubrication chamber.

18. A razor cartridge according to claim 17 wherein at least one interior plate portion includes a lubricant-distributional aperture.

19. A razor cartridge according to claim 17 which includes at least one skin relubrication chamber.

20. A razor cartridge according to claim 17, which includes at least one lubricant-directing rudder.

21. A razor cartridge according to claim 20, wherein at least one of said relubrication chamber is dependently fitted with a lubrication grid.

22. A method according to claim 1, in which said lubricant includes an oil.

23. A method according to claim 22, in which said lubricant includes in which the lubricant oil includes a small amount of silicone.

24. A method according to claim 1, in which the lubricant oil is a gel.

25. A method according to claim 1, in which the lubricant is a cream.

26. A method according to claim 1, in which the lubricant is a foam.
